(19) United States
(12) Patent Application Publication
(10) Pub. No.: US 2010/0025496 A1
(43) Pub. Date: Feb. 4, 2010

(54) Apparatus for Watering or Treating Plants

(76) Inventors: Jocelyn Raymond Fitzsimons, Cork (IE); Patrick Joseph Duffy, County Dublin (IE)

Correspondence Address: SUGHRUE MION, PLLC, 2100 PENNSYLVANIA AVENUE, N.W., SUITE 800, WASHINGTON, DC, 20037, US

(21) Appl. No.: 12/444,784

(22) PCT Filed: Oct. 9, 2007
(86) PCT No.: PCT/IE2007/000098

§ 371 Date: Jun. 16, 2009

(30) Foreign Application Priority Data
Oct. 9, 2006 (IE) S2006/0737

(51) Int. Cl. A01G 25/14

(52) U.S. Cl. 239/377; 222/174

(57) ABSTRACT

Apparatus (1) for watering plants in a hanging basket or window box at a relatively high level comprises a container (10) for water pivotally carried at a distal end (6) of a shaft (4). A cap (27) secured to a discharge outlet (12) is provided with a plurality of discharge bores (30) extending therethrough for facilitating discharge of water in a sprinkle type spray from the container (10). A pivot mounting (14) having a first pivot pin (18) pivotally couples the container (10) to a shaft (4) so that the container (10) is pivotal from a first orientation illustrated in FIG. 7 inhibiting discharge of water from the container (10) to a second orientation illustrated in FIG. 8 for discharging water through the discharge outlet (12). The pivot mounting (14) is located on the container (10) relative to the centre of gravity (32) thereof so that as the shaft (4) is rotated through 180° from the orientation illustrated in FIG. 7 to that illustrated in FIG. 8, the container (10) is pivoted from the first orientation to the second orientation.

The present invention relates to apparatus for watering or treating plants at a relatively high level with a solution with fluid-like characteristics, for example, a liquid solution, such as water, a liquid fertiliser, an aqueous based insecticide solution, an aqueous based fungicide solution, or the like.

Window boxes which contain plants and in particular, hanging baskets which contain plants, in general, are provided at a relatively high level, which in certain buildings may be at a level a number of storeys of the building above ground level. In many instances such window boxes, and in particular, hanging baskets are not accessible at a level adjacent or above the window box or hanging basket, and thus, must be watered by a person standing on the ground. This, in general, requires that a person standing on the ground holding a hose which is capable of delivering water at a relatively high pressure directs the hose for delivering the water upwardly so that having reached the peak of its trajectory, the water falls onto the plants in the window box or hanging basket. This is unsatisfactory, since it results in wetting of the building adjacent the window box or hanging basket and the ground beneath the hanging basket or window box. Indeed, where such hanging baskets or window boxes are located on a building which fronts directly onto a footpath, pavement or the like, watering such window boxes or hanging baskets with a hose may result in wetting of people passing by during the watering process.

Canadian Patent Specification No. 2,247,771 of David Pelley discloses a tipping watering can which is provided for watering plants in a hanging basket or in a window box. The tipping watering can comprises an open mouth bucket pivotally carried at the distal end of an elongated shaft. A U-shaped mounting bracket is secured at the distal end of the shaft, and pivotally carries the bucket, so that the bucket can be tipped from an orientation with an open mouth of the bucket facing upwardly for retaining water in the bucket to a substantially inverted orientation for discharging water from the bucket. The shaft onto which the bucket is pivotally mounted terminates at its opposite proximal end in a handle for facilitating holding the shaft in one hand. An elongated lever extends parallel to the shaft from the proximal end thereof and is coupled to the bucket for tipping the bucket for discharging water therefrom. By gripping the handle at the proximal end of the shaft in one hand and the lever in the other hand, and moving the lever along the shaft, the bucket is pivoted on the mounting bracket for discharging water therefrom through the open mouth thereof to the plants in the hanging basket or the window box.

The tipping watering can disclosed in this Canadian specification suffers from many disadvantages. Firstly, because of the construction of the bucket, it is virtually impossible, if not entirely impossible, to control the flow rate of water from the bucket, thus leading to water being splashed onto the side of a building and the ground beneath the plants being watered. Secondly, since one hand of an individual using the tipping watering can is required to operate the lever for pivoting the bucket, only one hand remains for holding the shaft on which the bucket is pivotally carried. Thus, an individual must balance the elevated bucket with one hand, which is virtually impossible, unless the volume and weight of the bucket is relatively small. Otherwise, the bucket when elevated would sway. Thus, an individual using the tipping watering can would have to control the swaying bucket with one hand while trying to operate the lever with the other hand to pivot the bucket to discharge and control the rate of discharge of the water from the bucket. This level of co-ordination is virtually impossible to achieve. Thirdly, once the bucket has been pivoted into an orientation for delivering water therefrom, pivoting the bucket using the lever to return the bucket to an orientation for inhibiting further delivery of water from the bucket is also particularly difficult. Fourthly, tipping the bucket can only be achieved by operating the actuating lever, and where the bucket is substantially full of water, urging the bucket into an orientation for discharging water therefrom, as discussed above, requires a relatively high level of co-ordination, which, in general, is impossible to achieve. Indeed, because of the relatively high level of co-ordination required in order to tip the bucket into an orientation for discharging water, a person operating the lever can cause imbalance in the apparatus, thus leading to toppling of the apparatus.

There is therefore a need for apparatus for watering or treating plants at a relatively high level with water or a solution having fluid-like characteristics which overcome the problems of the prior art.

The present invention is directed towards providing apparatus for watering or treating plants with water or a solution having fluid-like characteristics which addresses the problems of known apparatus.

According to the invention there is provided apparatus for watering or treating plants at a relatively high level with water or a solution with fluid-like characteristics, the apparatus comprising an elongated shaft defining a main central axis and extending from a proximal end to a distal end, a container defining a hollow interior region for water or the solution and having a discharge outlet for accommodating the water or solution from the hollow interior region therethrough, a mounting means for mounting the container on the shaft at the distal end thereof so that the container is moveable between a first orientation for inhibiting discharge of water or the solution through the discharge outlet and a second orientation for facilitating discharge of water or the solution through the discharge outlet, the mounting means being located on the container relative to the centre of gravity thereof, so that when the shaft is inclined upwardly towards the distal end thereof relative to the horizontal, and the container is in one of the first and second orientations, rotation of the shaft about the main central axis through approximately 180° tips the container from one of the first and second orientations to the other one of the first and second orientations.

In one embodiment of the invention the mounting means mounts the container on the shaft so that the container is in a first stable equilibrium state in the first orientation. Preferably, the mounting means mounts the container on the shaft so that the container is in a second stable equilibrium state in the second orientation. Advantageously, the mounting means mounts the container to the shaft so that the container passes through an unstable equilibrium state between the first orientation and the second orientation.

In another embodiment of the invention the container is tippable from one of the first and second orientations to the other one of the first and second orientations by rotating the shaft through approximately 180° while the shaft is inclined at an angle to the horizontal in the range of 40° to 80°. Preferably, the container is tippable from one of the first and second orientations to the other one of the first and second orientations by rotating the shaft through approximately 180° while the shaft is inclined at an angle to the horizontal in the range of 50° to 80°. Advantageously, the container is tippable from one of the first and second orientations to the other one of the first and second orientations by rotating the shaft through approximately 180° while the shaft is inclined at an angle to the horizontal in the range of 60° to 80°.

In one embodiment of the invention the mounting means is a pivotal mounting means defining a pivot axis about which the container is pivotal between the first and second orientations. Preferably, the pivot axis extends substantially horizontally when the container is in one of the first and second orientations.

Preferably, the pivot axis is located close to but spaced apart from the centre of gravity of the container. Advantageously, the container defines a longitudinally extending central axis, and the centre of gravity of the container is located on the central axis of the container, and the pivot axis is located close to the central axis of the container. Ideally, the mounting means is located in a recess formed in a shell of the container.

Alternatively, the mounting means comprises a linkage mechanism for mounting the container on the shaft. Preferably, the linkage mechanism comprises a pair of link members pivotally connected to the shaft by spaced apart first pivot mountings, and pivotally connected to the container by spaced apart second pivot mountings, the link members crossing each other as they extend between the corresponding first and second pivot mountings. Advantageously, the first and second pivot mountings define respective first and second pivot axes extending parallel to each other.

Preferably, the mounting means mounts the container on the shaft so that the locus of travel of the centre of gravity of the container extends approximately 180° around the main central axis as the shaft is being rotated about the main central axis.

In another embodiment of the invention a nudging means is provided for nudging the container from the first orientation to the second orientation. Preferably, the nudging means nudges the container past the unstable equilibrium state. Advantageously, the nudging means is located adjacent the distal end of the shaft, and is operable remotely by an operating means located adjacent the proximal end of the shaft. Ideally, the nudging means is pivotally mounted on the shaft.

In one embodiment of the invention the nudging means comprises a nudging lever extending between a container engaging end for engaging the container for nudging the container from the first to the second orientation, and an operating end. Advantageously, the operating end of the nudging lever is adapted for coupling to the operating means.

In another embodiment of the invention an urging means is provided for urging the container into the first orientation. Preferably, the urging means comprises a tension spring acting between the container and the shaft.

In another embodiment of the invention the container comprises a bulbous portion terminating in a neck defining the discharge outlet. Preferably, the container tapers inwardly from the bulbous portion thereof towards the neck. Advantageously, a nozzle is provided adjacent the discharge outlet through which the water or solution is delivered from the hollow interior region. Ideally, the nozzle comprises a nozzle plate having a plurality of spaced apart bores extending therethrough so that the water or solution is discharged through the nozzle in the form of a sprinkle type spray.

In another embodiment of the invention an air vent is provided to the hollow interior region for accommodating air into the hollow interior region during discharge of water or the solution therefrom.

In another embodiment of the invention the air vent is fitted with a non-return valve for admitting air into the hollow interior region.

Preferably, the shaft terminates at its proximal end in a handle for gripping thereof.

In one embodiment of the invention the apparatus is adapted for treating the plants with a liquid solution.

The invention also provides apparatus for watering or treating plants at a relatively high level with water or a solution with fluid-like characteristics, the apparatus comprising an elongated shaft extending from a proximal end to a distal end, a container defining a hollow interior region for water or the solution and having a discharge outlet for accommodating water or the solution from the hollow interior region therethrough, a mounting means for mounting the container on the shaft at the distal end thereof so that the container is moveable between a first orientation for inhibiting discharge of the water or solution through the discharge outlet, and a second orientation for facilitating discharge of the water or solution through the discharge outlet, an urging means for urging the container into one of the first and second orientations, and an actuating means for urging the container from the one of the first and second orientation into which the container is urged by the urging means to the other one of the first and second orientations.

Preferably, the urging means urges the container into the first orientation, and the actuating means is provided for urging the container from the first orientation to the second orientation. Advantageously, the urging means is a resilient urging means. Ideally, the urging means comprises a spring acting between the container and the shaft, and preferably, the urging means comprises a tension spring.

Preferably, the actuating means is manually operable remotely of the container. Advantageously, the actuating means comprises a pull cord. Ideally, the pull cord is coupled to the container. Preferably, the pull cord extends from the container to the proximal end of the shaft, and ideally, the pull cord is coupled to the shaft adjacent the proximal end thereof.

In one embodiment of the invention the mounting means is a pivotal mounting means defining a pivot axis about which the container is pivotal between the first and second orientations. Preferably, the pivot axis extends substantially horizontally when the container is in one of the first and second orientations. Advantageously, the pivot axis is located close to but spaced apart from the centre of gravity of the container. Preferably, the container defines a longitudinally extending central axis, and the centre of gravity of the container is located on the central axis of the container, and the pivot axis is located close to the central axis of the container. Ideally, the mounting means is located in a recess formed in a shell of the container.

The advantages of the invention are many. The invention provides apparatus for watering plants at a relatively high level, which is relatively simple to use by a person standing on the ground with little effort being required, and adequately waters the plants with the minimum of water spill, and in general, with no water spill. By pivotally coupling the container to the shaft of the apparatus, a relatively simple and easy to use apparatus is provided, which can also be relatively easily and inexpensively manufactured.

The provision of the nudging means facilitates operating the apparatus when the angle at which the shaft is inclined upwardly to the horizontal is relatively large, and is particularly useful when the apparatus is being used for watering or treating plants in a relatively high hanging basket or window box.

By providing the apparatus with an urging means for urging the container into the first orientation and an actuating means for urging the container from the first to the second orientation provides apparatus which can be used for watering plants at a higher level than is possible with the apparatus which does not include the urging means and the actuating means. However, the provision of the actuating means and the urging means does add somewhat to the complexity of the apparatus, and therefore in many cases the apparatus without the urging means and the actuating means is adequate for watering plants at a relatively high level, but lower than the level at which plants can be watered with the apparatus which comprises the urging and actuating means.

A further advantage of the invention is achieved by providing the container with a bulbous portion which tapers inwardly to a neck which defines the discharge outlet. The provision of the bulbous portion provides the container with a relatively large capacity for water or other plant treatment solutions, and by tapering the container from the bulbous portion to the neck, which in turn defines the discharge outlet, allows the flow rate of water from the container to be relatively easily controlled and accurately directed when the container is in the second orientation and also allows the container to be relatively accurately positioned.

By providing the nozzle with a plurality of spaced apart bores, water and other such plant treatment solutions are discharged from the container in the form of a sprinkle type spray. Additionally, by tapering the container from the bulbous portion to the neck results in a container which requires the minimum angular movement between the first orientation whereby discharge of water is inhibited and the second orientation for facilitating discharge of water therefrom. The provision of the container tapering to a neck which defines the discharge outlet facilitates relatively accurate direction of water to the plants, thereby minimising and in most cases eliminating spillage.

A further advantage of the invention is achieved by virtue of the fact that the apparatus can be readily easily controlled, and furthermore, by virtue of the fact that the container can readily easily be operated between the first and second orientations by merely rotating the shaft through approximately 180°, the flow of water or other solution from the container can be readily easily activated and deactivated, and therefore, the volume of water discharged can be readily easily controlled. This is a particular advantage when one is watering hanging baskets or window boxes when the soil is relatively hard, since it allows initially a small volume of water to be discharged into the hanging basket or window box to allow softening of the soil, and then subsequently by degrees the volume of water discharged into the hanging basket or window box can be progressively increased. Thus, a person watering a hanging basket or a window box in which the soil is relatively hard and dry can use the apparatus at intervals for watering the hanging basket or window box, and as the soil becomes moist and softens, the volume of water discharged into the hanging basket or window box can be progressively increased.

The invention will be more clearly understood from the following description of some preferred embodiments thereof, which are given by way of example only, with reference to the accompanying drawings, in which:

FIG. 1 is a side elevational view of apparatus according to the invention for watering plants,

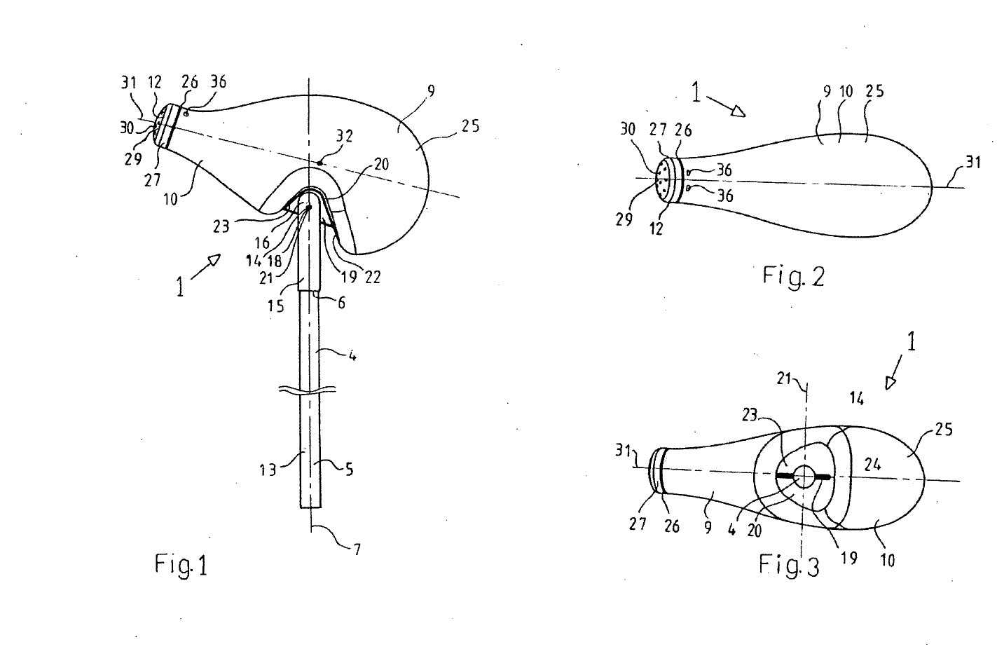

FIG. 2 is a top plan view of the apparatus of FIG. 1,

FIG. 3 is an underneath plan view of the apparatus of FIG. 1,

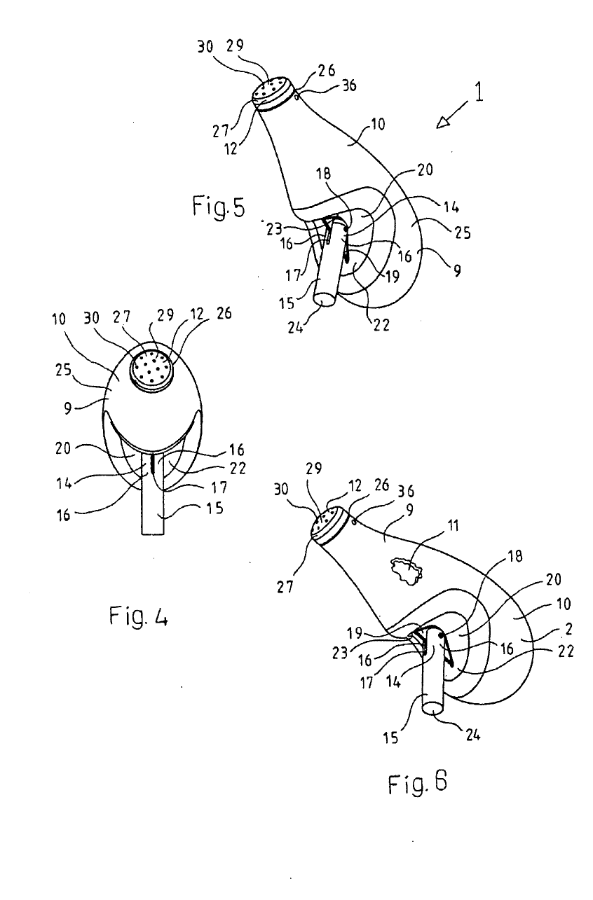

FIG. 4 is an end elevational view of a portion of the apparatus of FIG. 1,

FIG. 5 is a perspective view of the portion of FIG. 4 of the apparatus of FIG. 1,

FIG. 6 is a partly cutaway perspective view of the portion of FIG. 4 of the apparatus of FIG. 1,

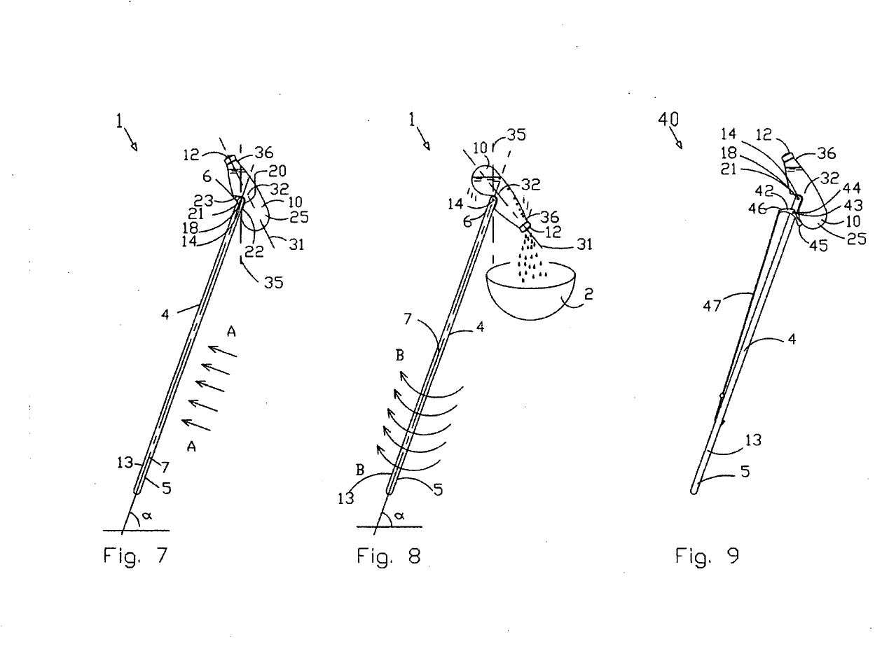

FIG. 7 is a side elevational view of the apparatus of FIG. 1 illustrating a portion of the apparatus in one orientation,

FIG. 8 is a side elevational view of the apparatus of FIG. 1 illustrating the portion of the apparatus in a different orientation to that of FIG. 7,

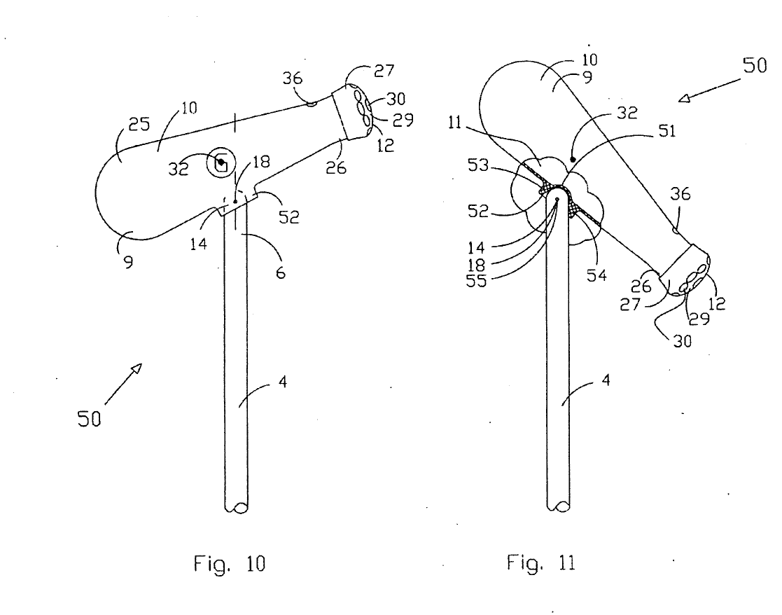

FIG. 9 is a side elevational view of apparatus according to another embodiment of the invention for watering plants,

FIG. 10 is a side elevational view of apparatus according to another embodiment of the invention for watering plants,

FIG. 11 is a partly sectional side elevational view of the apparatus of FIG. 10,

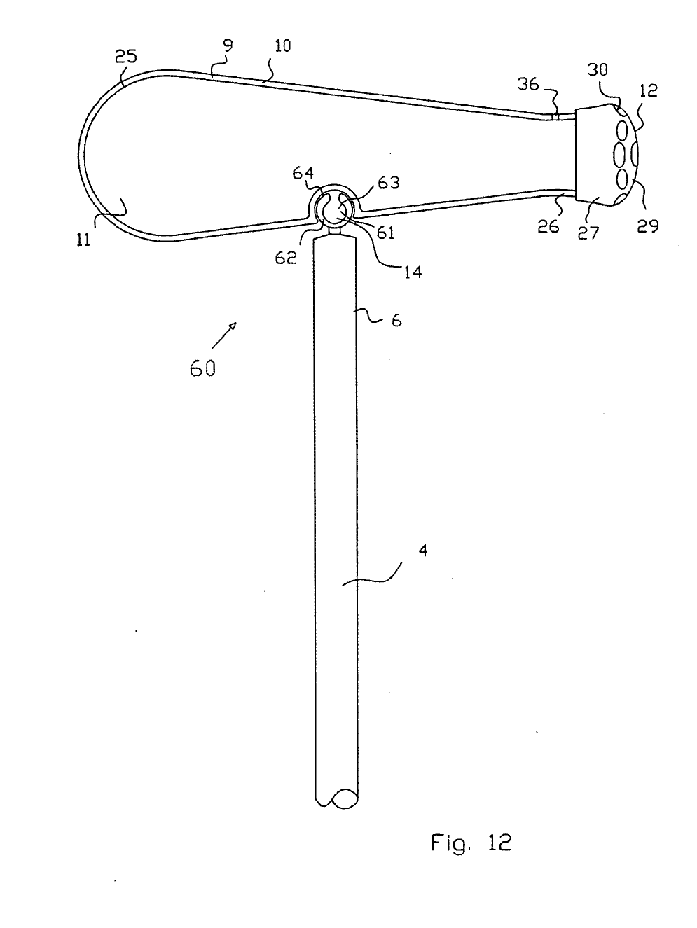

FIG. 12 is a cross-sectional side elevational view of apparatus according to another embodiment of the invention for watering plants,

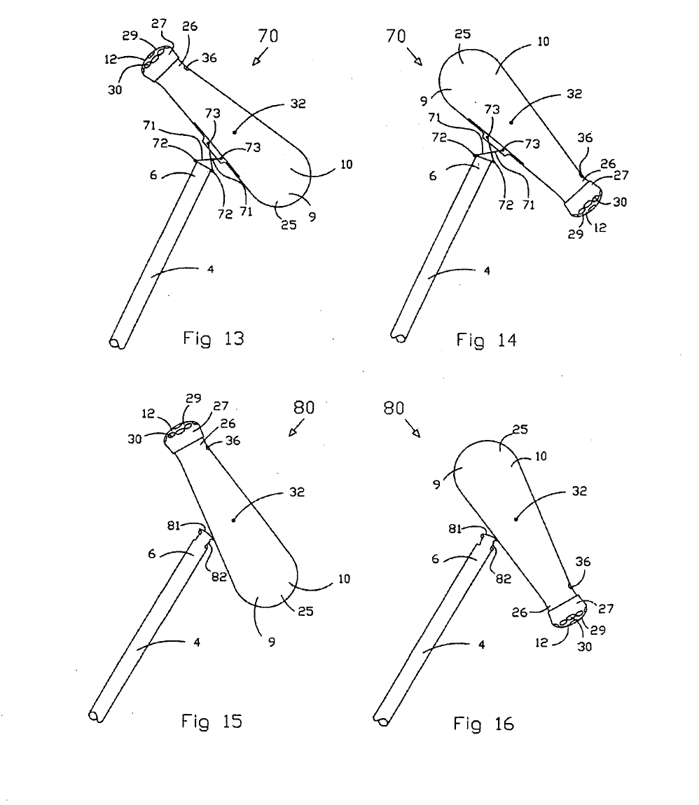

FIG. 13 is a side elevational view of apparatus according to another embodiment of the invention for watering plants,

FIG. 14 is a side elevational view of the apparatus of FIG. 13 illustrating a portion of the apparatus in a different orientation,

FIG. 15 is a side elevational view of apparatus according to a further embodiment of the invention for watering plants,

FIG. 16 is a side elevational view of the apparatus of FIG. 15 illustrating a portion of the apparatus in a different orientation, and

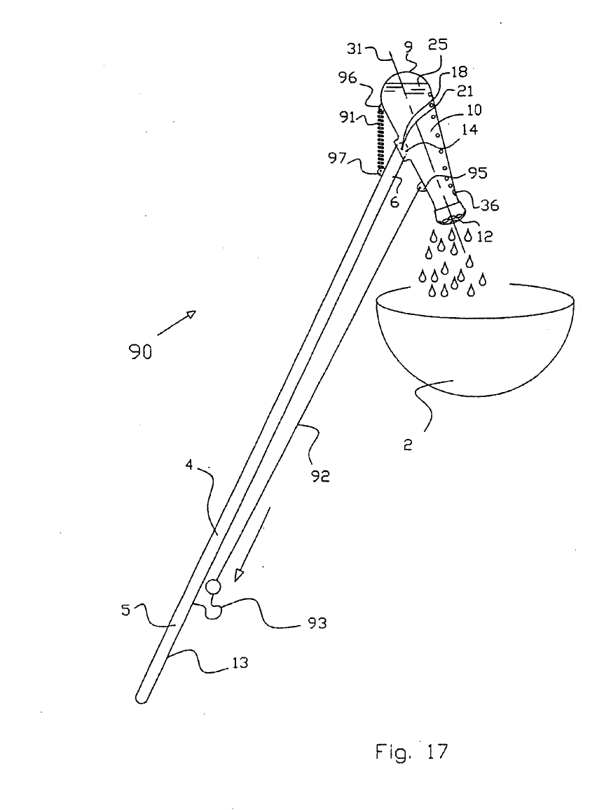

FIG. 17 is a side elevational view of apparatus according to a still further embodiment of the invention for watering plants.

Referring to the drawings and initially to FIGS. 1 to 8 thereof, there is illustrated apparatus according to the invention, indicated generally by the reference numeral 1, for watering plants at a relatively high level, for example, plants in a hanging basket 2, which is illustrated in FIG. 8, a window box or the like. The apparatus 1 is also suitable for treating the plants with a liquid solution, for example, a fertiliser, an aqueous based insecticide solution, an aqueous based fungicide solution or the like. The apparatus 1 comprises an elongated shaft 4 which extends from a proximal end 5 to a distal end 6 and defines a main central axis 7. A container 10 formed by a shell 9 defines a hollow interior region 11 for water or other liquid solution, and a discharge outlet 12 accommodates water from the hollow interior region 11. A mounting means provided by a pivot mounting 14 pivotally couples the container 10 to the distal end 6 of the shaft 4, so that the container 10 is pivotal between a first orientation illustrated in FIG. 7 for inhibiting discharge of water from the container 10 and a second orientation illustrated in FIG. 8 for facilitating discharge of water from the container 10, as will be described in more detail below. The proximal end 5 of the shaft 4 forms a handle portion 13 for holding the apparatus 1 during watering of plants.

The pivot mounting 14 comprises a tubular mounting member 15 mounted on the distal end 6 of the shaft 4, and terminating in spaced apart side lugs 16, which define a slot 17 therebetween. A pivot pin 18 carried in the side lugs 16 extends across the slot 17 and pivotally engages a pivot bore (not shown) in a plate member 19 located in a recess 20 formed in the shell 9 of the container 10. The pivot pin 18 defines a pivot axis 21 about which the container 10 is pivotal between the first and second orientations. A first abutment 22 and a second abutment 23, both of which are formed by the shell 9 of the container 10 in the recess 20 limit the pivotal movement of the container 10 about the pivot pin 18 between the first and second orientations so that the tubular mounting member 15 abuts the first abutment 22 when the container is in the first orientation for retaining the container 10 in a first stable equilibrium state in the first orientation, and abuts the second abutment 23 when the container 10 is in the second orientation for retaining the container 10 in a second stable equilibrium state in the second orientation. A bore 24 extending into the tubular mounting member 15 engages the distal end 6 of the shaft 4 for pivotally securing the container 10 to the shaft 4.

The shell 9 of the container 10 forms a bulbous portion 25 which tapers inwardly towards a neck 26 which defines the discharge outlet 12. A cap 27 is releasably engageable with an outer portion (not shown) of the neck 26, and comprises a discharge plate 29 having a plurality of discharge bores 30 extending therethrough for accommodating water and other liquid solutions from the hollow interior region 11 in the form of a sprinkle type spray, see FIG. 8. The end cap 27 engages the peripheral portion of the neck 26 with a snap-fit action for facilitating removal of the cap 27 for filling the container 10.

The container 10 defines a longitudinally extending central axis 31, and when empty defines the centre of gravity 32 on the central axis 31. The container 10 is mounted by the pivot mounting 14 to the shaft 4 so that when the shaft 4 is inclined at an angle α to the horizontal up to approximately 60° with the pivot axis 21 extending horizontally, by rotating the shaft 4 about the main central axis 7 through 180°, the container 10 is pivoted about the pivot axis 21 from one of the first and second orientations to the other of the first and second orientations, see FIGS. 7 and 8. In FIG. 7 the apparatus 1 is illustrated with the shaft 4 at an angle of approximately 60° to the horizontal and the pivot axis 21 extending horizontally. The container 10 in FIG. 7 is illustrated in the first stable equilibrium state in the first orientation with the centre of gravity 32 located to one side of a vertical plane 35 containing the pivot axis 21 away from the shaft 4, thus maintaining the container 10 in the first orientation with the discharge outlet 12 facing upwardly, inhibiting discharge of water therefrom. In FIG. 8 the shaft 4 still extending at an angle α of approximately 60° to the horizontal has been rotated through approximately 180°, with the pivot axis 21 again extending horizontally and with the container 10 in the second stable equilibrium state in the second orientation for facilitating the discharge of water through the discharge outlet 12. In FIG. 8 the centre of gravity 32 of the container 10 has been displaced and again lies to one side of the vertical plane 35 containing the pivot axis 21 on the side away from the shaft 4.

As the shaft 4 is being rotated through approximately 180° about the main central axis 7 of the shaft 4, the centre of gravity 32 of the container 10 is rotated about the main central axis 7 through 180° approximately, thereby resulting in the container 10 going into an unstable equilibrium state, and as the rotation of the shaft 4 about the main central axis 7 approaches 180°, the position of the centre of gravity 32 of the container 10 causes the container 10 to pivot about the pivot axis 21 from the one of the first and second orientations into the other of the first and second orientations.

It has been found that by recessing the pivot mounting 14 into the shell 9 of the container 10 so that the pivot axis 21 about which the container 10 is pivotal relative to the shaft 4 is located relatively closely to the central axis 31 of the container 10, while at the same time being spaced apart from the centre of gravity 32 provides a relatively smooth transition of the container 10 between the first and second orientations thereof, and in particular minimises and substantially avoids any strong impacting of the first and second abutments 22 and 23 by the tubular mounting member 15 of the shaft 4 as the container 10 is approaching the first and second orientations.

Two air vents 36 are provided by respective bores of 2 mm diameter approximately through the shell 9 of the container 10 adjacent the neck 26 for accommodating air into the hollow interior region 11 of the container 10 during discharge of water or other solution therefrom.

In use, with the shaft 4 held substantially horizontally and orientated so that the container 10 is orientated with the discharge outlet facing upwardly, the cap 27 is removed from the neck 26, and the container 10 is filled with water or other liquid solution with which plants are to be treated. The cap 27 is then secured to the neck 26, and the apparatus 1 is ready for watering or treating the plants. With the shaft 4 extending horizontally, the pivot axis 21 extending horizontally and the container 10 in the orientation with the discharge outlet 12 facing upwardly, the shaft 4 is angled upwardly in the direction of the arrows A of FIG. 7 until the shaft 4 extends substantially at the angle α of 60° to the horizontal, and the container 10 is at a level above and adjacent the hanging basket 2 to be watered. In this position the container 10 is in the first orientation in the first stable equilibrium state, thereby preventing discharge of water from the container 10. To water or treat the plants in the basket 2, the shaft 4 is rotated about the main central axis 7 in the direction of the arrows B through an angle of approximately 180°, see FIG. 8, and as the shaft 4 is being rotated, the container 10 is urged from the first orientation in the first stable equilibrium state to the second orientation into the second stable equilibrium state as the centre of gravity 32 of the container 10 is rotated about the main central axis 7 of the shaft 4. In the second orientation of the container 10, see FIG. 8, water is discharged therefrom in a sprinkle type spray through the bores 30 in the discharge plate 29 of the cap 27 for watering the plants.

When watering has been completed, the shaft 4 is again rotated about the main central axis through approximately 180°, and as the shaft 4 is being rotated, the centre of gravity 32 is rotated through 180° about the main central axis 7, thereby causing the container 10 to be urged from the second orientation back to the first orientation. In the first orientation water is again prevented from being discharged through the discharge outlet 12 and the apparatus 1 may then be moved to the next hanging basket or window box to be watered and the operation repeated again.

Referring now to FIG. 9, there is illustrated apparatus 40 according to another embodiment of the invention also for watering plants or treating such plants with a liquid solution at a relatively high level in, for example, a hanging basket, window box or the like. The apparatus 40 is substantially similar to the apparatus 1 and similar components are identified by the same reference numerals. The only difference between the apparatus 40 and the apparatus 1 is that a nudging means provided by a nudging lever 42 which is pivotally mounted on the shaft 4 is provided for nudging the container 10 from the first orientation to the second orientation as the shaft 4 is being rotated about the main central axis 7 through 180°. The nudging lever 42 is pivotally coupled to the shaft 4 by a pivot pin 43 which defines a pivot axis 44 which extends parallel to the pivot axis 21 of the pivot pin 18. The nudging lever 42 extends between a container engaging end 45 which engages the bulbous portion 25 of the container 10 for tipping the container 10 from the first to the second orientation, and an operating end 46. An operating means, namely, a pull cord 47 is coupled to the operating end 46 of the nudging lever 42 and is anchored to the shaft 4 adjacent the handle 13 at the proximal end 5 thereof for facilitating remote operation of the nudging lever 42 for tipping the container 10 from the first orientation to the second orientation as the shaft is being rotated-through 180°.

Use of the apparatus 40 is similar to that of the apparatus 1, with the exception that as the shaft 4 is being rotated through 180° about the main central axis 7 for urging the container 10 from the first to the second orientation, the pull cord 47 is pulled downwardly to operate the nudging lever 42 for nudging the container 10 from the first to the second orientation. Otherwise, the apparatus 40 and its use is similar to that of the apparatus 1.

Referring now to FIGS. 10 and 11, there is illustrated apparatus according to another embodiment of the invention, indicated generally by the reference numeral 50, for watering or treating plants with a liquid solution at a relatively high level. The apparatus 50 is substantially similar to the apparatus 1 and similar components are identified by the same reference numerals. The main difference between the apparatus 50 and the apparatus 1 is in the pivot mounting 14 of the container 10 to the shaft 4. In this embodiment of the invention a socket 51 is formed in the shell 9 of the container 10 which defines a pair of side walls 52 joined by first and second end walls 53 and 54, respectively. The pivot pin 18 is carried in the side walls 52 and extends between the side walls 52 across the socket 51 for engaging a pivot bore 55 in the distal end 6 of the shaft 4. The first end wall 53 acts as a first abutment for engaging the distal end 6 of the shaft 4 when the container 10 in the first orientation, while the second end wall 54 acts as a second abutment for engaging the distal end 5 of the shaft 4 when the container 10 is in the second orientation.

Otherwise the apparatus 50 and its use is similar to that of the apparatus 1.

Referring now to FIG. 12, there is illustrated apparatus according to another embodiment of the invention, indicated generally by the reference numeral 60, also for watering or treating plants in a hanging basket, window box or the like. The apparatus 60 is substantially similar to the apparatus 1 and similar components are identified by the same reference numerals. The main difference between the apparatus 60 and the apparatus 1 is in the pivot mounting 14 of the container 10 to the shaft 4. In this embodiment of the invention the container 10 is pivotally coupled to the shaft 4 by a ball and socket type coupling 61. A socket 62 of the ball and socket coupling 61 is mounted on the distal end 6 of the shaft 4, while a ball 63 of the ball and socket coupling 61 engageable with the socket 62 extends from the container 10 in a recess 64 thereof.

Otherwise, the apparatus 60 and its use is similar to that of the apparatus 1.

Referring now to FIGS. 13 and 14, there is illustrated apparatus according to another embodiment of the invention, indicated generally by the reference numeral 70, also for watering plants in a hanging basket, window box or the like. The apparatus 70 is substantially similar to the apparatus 1 and similar components are identified by the same reference numerals. The main difference between the apparatus 70 and the apparatus 1 is in the mounting of the container 10 to the shaft 4. In this embodiment of the invention the container 10 is mounted on the distal end 6 of the shaft 4 by a linkage mechanism, which comprises a pair of link members 71 which are pivotally coupled to the shaft 4 by spaced apart first pivot mountings 72 at the distal end 6 of the shaft 4 and are pivotally coupled to the container 10 by spaced apart second pivot mountings 73 on the container 10. The link members 71 cross each other between the first and second pivot mountings 72 and 73, so that the container 10 is constrained to move between the first and second orientation with a tipping type action.

Otherwise, the apparatus 70 and its use is similar to the apparatus 1.

Referring now to FIGS. 15 and 16, there is illustrated apparatus according to a still further embodiment of the invention, indicated generally by the reference numeral 80, also for watering and treating plants in a hanging basket or window box or the like. The apparatus 80 is substantially similar to the apparatus 1 and similar components are identified by the same reference numerals. The main difference between the apparatus 80 and the apparatus 1 is in the mounting arrangement for mounting the apparatus 80 to the distal end 6 of the shaft 4. In this embodiment of the invention the container 10 is loosely coupled to the shaft 4 by wires 81 and 82, so that the container 10 can move between the first and second orientations while the wires 81 and 82 retain and hold the container 10 to the shaft 4.

Referring now to FIG. 17, there is illustrated apparatus according to a still further embodiment of the invention, indicated generally by the reference numeral 90, also for watering plants in a hanging basket or a window box. The apparatus 90 is substantially similar to the apparatus 1 and similar components are identified by the same reference numerals. In this embodiment of the invention the container 10 is pivotally coupled to the shaft 4 by a pivot mounting 14 which is similar to the pivot mounting 14 of the apparatus 50. However, the container 10 is urged by an urging means provided by a tension spring 91 into the first orientation. The tension spring 91 is coupled to the container 10 at 96 and to the shaft 4 at 97.

An actuating means comprising a pull cord 92 coupled between a mounting 93 on the shaft 4 adjacent the handle 13 and a mounting 95 on the container 10 is provided for urging the container 10 against the spring action from the first orientation to the second orientation for watering plants in a hanging basket 2 or a window box. Since the container 10 in this embodiment of the invention is urged into the first orientation by the tension spring 91, and is manually urged from the first orientation to the second orientation by the pull cord 92, the location of the centre of gravity in the container is not important, and may be located anywhere in the container, relative to the shaft 4 and the main central axis 7. However, in order to balance the container 10 on the shaft 4 and to minimise the effort required to urge the container 10 from the first to the second orientation, it is desirable that the pivot axis 21 about which the container 10 pivots between the first and the second orientations is located relatively closely to the centre of gravity of the container 10.

In use, with the container 10 charged with water or other treating solution, the shaft 4 is angled upwardly with the container 10 in the first orientation until the container 10 is at a level above the hanging basket or window box, the plants of which are to be watered or treated. The pull cord 92 is pulled downwardly for urging the container 10 from the first orientation to the second orientation, and pull is retained on the pull cord 92 for retaining the container 10 in the second orientation until the plants in the hanging basket or window box have been adequately watered or treated. On completion of watering, the pull cord 92 is gradually released, thereby permitting the container 10 to pivot from the first to the second orientation under the action of the tension spring 91.

Since the apparatus 90 is provided with the tension spring 91 for urging and retaining the container 10 in the first orientation, and the pull cord 92 for urging the container 10 against the action of the tension spring 91 into the second orientation, there is no need to rotate the shaft 4 through 180° about the main central axis 7 in order to cause pivoting of the container 10 from the first to the second orientation.

Although in this embodiment of the invention the pivot pin 18 and in turn the pivot axis 21 about which the container 10 is pivotal on the shaft 4 is illustrated as being spaced apart quite a distance from the centre line 31 and in turn from the centre of gravity of the container 10, in practice it is desirable that the pivot mounting 14 should be located in a recess in the shell 9 of the container 10, similar to the recess 20 in the container 10 of the apparatus 1, in order that the pivot axis 21 should be relatively close to the centre line 31 and also to the centre of gravity of the container 10 to smooth the transition of the container 10 between the first and second orientations. Indeed, in this embodiment of the invention since the container 10 is urged into the first orientation by the tension spring 91 and is urged into the second orientation by the pull cord 92, the pivot axis 21 of the pivot mounting 14 could coincide with the centre of gravity 32 of the container 10.

Since in the embodiments of the invention described with reference to FIGS. 9 and 17, the pull cords 47 and 92 of the respective apparatus 40 and 90 are anchored to the shaft 4 adjacent the handle 13, the handle 13 of both apparatus 40 and 90 can be gripped by both hands of an individual using the apparatus, while simultaneously pulling the pull cord 47 and 49, as the case may be, with, for example, a finger of one of the hands gripping the handle, thereby avoiding any danger of toppling of the apparatus due to imbalance when the container 10 is elevated.

While the apparatus have been described with the containers as being provided with one or more specific types of air vents, it will be readily apparent to those skilled in the art that any other types of air vents may be provided. Indeed, it is envisaged that in many cases a non-return valve may be located in the air vent or air vents, which would admit air into the hollow interior region of the container 10 during discharge of water therefrom, and prevent reverse flow of air or water through the air vent.

It is also envisaged that instead of locating the air vent adjacent the neck of the container, the air vent may be provided towards the end of the bulbous part of the container or at the top thereof, and a communicating tube communicating with the air vent would extend from the air vent and terminate in a vent opening adjacent the neck of the container. By so arranging the communicating tube extending from the air vent, leakage of water or other solution from the container would be avoided, and in particular, air would be drawn into the hollow interior region without bubbling through the water or other solution in the container, thereby facilitating discharge of the water or other solution from the container in a smooth sprinkle type spray.

While the apparatus has been described for use while the shaft is held at an angle of approximately 60° to the horizontal, it will be readily apparent to those skilled in the art that the apparatus may be operated by holding the shaft at any suitable angle to the horizontal, however, it is envisaged that optimum results are achieved when the apparatus is operated with the shaft extending at an angle between 40° and 80° to the horizontal.

1-58. (canceled)

59. Apparatus for watering or treating plants at a relatively high level with water or a solution with fluid-like characteristics, the apparatus comprising an elongated shaft defining a main central axis and extending from a proximal end to a distal end, a container defining a hollow interior region for water or the solution and having a discharge outlet for accommodating the water or solution from the hollow interior region therethrough, a mounting means for mounting the container on the shaft at the distal end thereof so that the container is moveable between a first orientation for inhibiting discharge of water or the solution through the discharge outlet and a second orientation for facilitating discharge of water or the solution through the discharge outlet, the mounting means being located on the container relative to the centre of gravity thereof, so that when the shaft is inclined upwardly towards the distal end thereof relative to the horizontal, and the container is in one of the first and second orientations, rotation of the shaft about the main central axis through approximately 180° tips the container from one of the first and second orientations to the other one of the first and second orientations.

60. Apparatus as claimed in claim 59 in which the mounting means mounts the container on the shaft so that the container is in a first stable equilibrium state in the first orientation, and preferably, the mounting means mounts the container on the shaft so that the container is in a second stable equilibrium state in the second orientation, and advantageously, the mounting means mounts the container to the shaft so that the container passes through an unstable equilibrium state between the first orientation and the second orientation.

61. Apparatus as claimed in claim 59 in which the container is tippable from one of the first and second orientations to the other one of the first and second orientations by rotating the shaft through approximately 180° while the shaft is inclined at an angle to the horizontal in the range of 40° to 80°, and preferably, the container is tippable from one of the first and second orientations to the other one of the first and second orientations by rotating the shaft through approximately 180° while the shaft is inclined at an angle to the horizontal in the range of 50° to 80°, and advantageously, the container is tippable from one of the first and second orientations to the other one of the first and second orientations by rotating the shaft through approximately 180° while the shaft is inclined at an angle to the horizontal in the range of 60° to 80°.

62. Apparatus as claimed in claim 59 in which the mounting means is a pivotal mounting means defining a pivot axis about which the container is pivotal between the first and second orientations, and preferably, the pivot axis extends substantially horizontally when the container is in one of the first and second orientations, and advantageously, the pivot axis is located close to but spaced apart from the centre of gravity of the container.

63. Apparatus as claimed in claim 62 in which the container defines a longitudinally extending central axis, and the centre of gravity of the container is located on the central axis of the container, and the pivot axis is located close to the central axis of the container, and preferably, the mounting means is located in a recess formed in a shell of the container.

64. Apparatus as claimed in claim 59 in which the mounting means comprises a linkage mechanism for mounting the container on the shaft, and preferably, the linkage mechanism comprises a pair of link members pivotally connected to the shaft by spaced apart first pivot mountings, and pivotally connected to the container by spaced apart second pivot mountings, the link members crossing each other as they extend between the corresponding first and second pivot mountings, and preferably, the first and second pivot mountings define respective first and second pivot axes extending parallel to each other.

65. Apparatus as claimed in claim 59 in which the mounting means mounts the container on the shaft so that the locus of travel of the centre of gravity of the container extends approximately 180° around the main central axis as the shaft is being rotated about the main central axis.

66. Apparatus as claimed in claim 59 in which a nudging means is provided for nudging the container from the first orientation to the second orientation, and advantageously, the nudging means nudges the container past the unstable equilibrium state, and preferably, the nudging means is located adjacent the distal end of the shaft, and is operable remotely by an operating means located adjacent the proximal end of the shaft, and advantageously, the nudging means is pivotally mounted on the shaft, and preferably, the nudging means comprises a nudging lever extending between a container engaging end for engaging the container for nudging the container from the first to the second orientation, and an operating end, and advantageously, the operating end of the nudging lever is adapted for coupling to the operating means.

67. Apparatus as claimed in claim 59 in which an urging means is provided for urging the container into the first orientation, and preferably, the urging means comprises a tension spring acting between the container and the shaft.

68. Apparatus as claimed in claim 59 in which the container comprises a bulbous portion terminating in a neck defining the discharge outlet, and preferably, the container tapers inwardly from the bulbous portion thereof towards the neck.

69. Apparatus as claimed in claim 59 in which a nozzle is provided adjacent the discharge outlet through which the water or solution is delivered from the hollow interior region, and preferably, the nozzle comprises a nozzle plate having a plurality of spaced apart bores extending therethrough so that the water or solution is discharged through the nozzle in the form of a sprinkle type spray, and advantageously, an air vent is provided to the hollow interior region for accommodating air into the hollow interior region during discharge of water or the solution therefrom, and preferably, the air vent is fitted with a non-return valve for admitting air into the hollow interior region.

70. Apparatus as claimed in claim 59 in which the shaft terminates at its proximal end in a handle for gripping thereof, and preferably, the apparatus is adapted for treating the plants with a liquid solution.

71. Apparatus for watering or treating plants at a relatively high level with water or a solution with fluid-like characteristics, the apparatus comprising an elongated shaft extending from a proximal end to a distal end, a container defining a hollow interior region for water or the solution and having a discharge outlet for accommodating water or the solution from the hollow interior region therethrough, a mounting means for mounting the container on the shaft at the distal end thereof so that the container is moveable between a first orientation for inhibiting discharge of the water or solution through the discharge outlet, and a second orientation for facilitating discharge of the water or solution through the discharge outlet, an urging means for urging the container into one of the first and second orientations, and an actuating means for urging the container from the one of the first and second orientation into which the container is urged by the urging means to the other one of the first and second orientations.

72. Apparatus as claimed in claim 71 in which the urging means urges the container into the first orientation, and the actuating means is provided for urging the container from the first orientation to the second orientation, and advantageously, the urging means is a resilient urging means, and preferably, the urging means comprises a spring acting between the container and the shaft, and advantageously, the urging means comprises a tension spring.

73. Apparatus as claimed in claim 71 in which the actuating means is manually operable remotely of the container, and preferably, the actuating means comprises a pull cord, and preferably, the pull cord is coupled to the container, and advantageously, the pull cord extends from the container to the proximal end of the shaft, and preferably, the pull cord is coupled to the shaft adjacent the proximal end thereof.

74. Apparatus as claimed in claim 73 in which the mounting means is a pivotal mounting means defining a pivot axis about which the container is pivotal between the first and second orientations, and preferably, the pivot axis extends substantially horizontally when the container is in one of the first and second orientations, and advantageously, the pivot axis is located close to but spaced apart from the centre of gravity of the container.

75. Apparatus as claimed in claim 74 in which the container defines a longitudinally extending central axis, and the centre of gravity of the container is located on the central axis of the container, and the pivot axis is located close to the central axis of the container, and preferably, the mounting means is located in a recess formed in a shell of the container.

76. Apparatus as claimed in claim 73 in which the mounting means comprises a linkage mechanism for mounting the container on the shaft, and preferably, the linkage mechanism comprises a pair of link members pivotally connected to the shaft by spaced apart first pivot mountings, and pivotally connected to the container by spaced apart second pivot mountings, the link members crossing each other as they extend between the corresponding first and second pivot mountings, and preferably, the first and second pivot mountings define respective first and second pivot axes extending parallel to each other.

77. Apparatus as claimed in claim 71 in which the container comprises a bulbous portion terminating in a neck defining the discharge outlet, and preferably, the container tapers inwardly from the bulbous portion thereof towards the neck, and advantageously, a nozzle is provided adjacent the discharge outlet through which the water or solution is delivered from the hollow interior region, and preferably, the nozzle comprises a nozzle plate having a plurality of spaced apart bores extending therethrough so that the water or solution is discharged through the nozzle in the form of a sprinkle type spray, and preferably, an air vent is provided to the hollow interior region for accommodating air into the hollow interior region during discharge of the water or solution therefrom, and preferably, the air vent is fitted with a non-return valve for admitting air into the hollow interior region.

78. Apparatus as claimed in claim 71 in which the shaft terminates at its proximal end in a handle for gripping thereof, and preferably, the apparatus is adapted for treating the plants with a liquid solution.
